(19) United States
(12) Patent Application Publication
(10) Pub. No.: US 2015/0382203 A1
(43) Pub. Date: Dec. 31, 2015

(54) RADIO WAVE OBSERVATION SYSTEM, CENTRAL STATION DEVICE, AND RADIO WAVE OBSERVATION METHOD

(71) Applicant: NEC CORPORATION, Minato-ku, Tokyo (JP)

(72) Inventor: Masaki KITSUNEZUKA, Tokyo (JP)

(73) Assignee: NEC CORPORATION, Tokyo (JP)

(21) Appl. No.: 14/767,187

(22) PCT Filed: Jan. 30, 2014
(86) PCT No.: PCT/JP2014/052109

§ 371 Date: Aug. 11, 2015

(30) Foreign Application Priority Data
Feb. 12, 2013 (JP) 2013-024560

(51) Int. Cl. H04W 16/18; H04W 24/10

(52) U.S. Cl. CPC H04W 16/18; H04W 24/10

(57) ABSTRACT

[Problem] To observe radio wave usage circumstances over a wide area and convert same into a database, at an achievable cost. [Solution] A radio wave observation system comprises: a plurality of wireless networks, further respectively comprising multiple terminal stations (2) and a plurality of base stations (3), which carry out wireless communication between the terminal stations and the base stations; and a central station device (4) which is connected to these base stations. Each of the terminal stations (2) further comprises an observation device (2a) which carries out radio wave observation and returns the results of the observation to the central station device in response to an instruction from the central station device. The central station device (4) further comprises: a storage means (5), further comprising a radio wave circumstance database (5a) which records the radio wave circumstances for each observation point; a terminal search function (6) which identifies, for each measurement point, the terminal station which is associated with one of the plurality of wireless networks, the present location whereof being the closest to the measurement point; and a radio wave circumstance collecting function (7) which instructs the identified terminal station to carry out the radio wave observation, and records the returned results of the observation in the radio wave circumstance database.

### TECHNICAL FIELD

The present invention relates to a radio wave observation system, a central station device, and a radio wave observation method and program, and relates particularly to a radio wave observation system and the like that enable to observe states of radio wave use over a large area and create a database based thereon.

### BACKGROUND ART

Since radio communication devices such as mobile phones are widely used and that the amount of data transmitted via radio communications is increasing from day to day at an accelerated pace, the lack of frequency resources has been a problem. Causes of this problem are that wide frequency bands are needed in order to increase communication rates as well as that assigned frequency bands are not effectively used and that communications may not be carried out at original communication rates due to interference between wireless fidelity (Wi-Fi (registered trademark)) or wireless local area network (LAN) access points provided in an unregulated manner.

In view of these circumstances, research and development of cognitive radio have been conducted aiming at more effective use of frequency resources, that is, protecting primary users having license to use radio waves while enabling secondary use of unused frequency bands by visualizing, for each frequency, the state of radio wave use in each spot at each time point, and the like.

In parallel, research and development of software-defined radio (referred to as SDR below), which is one of the element technologies for effectively operating the cognitive radio, have been promoted. The SDR is a radio communication technology that enables a single piece of hardware to be compatible with multiple communication schemes (communication standards) by switching between radio communication functions only by software changes.

Examples of the technical documents relating this technology are as follows. Among the documents, a radio communication device that performs carrier sense for each of multiple radio channels and that carries out communications via a channel selected from those in the standby mode, is described in PTL 1. A radio wave monitor system that detects, for example, illegal radio waves by each terminal measuring the electric field strength in a predetermined frequency band and a monitoring center analyzing the measurement results, is described in PTL 2.

A radio communication system that detects available frequencies by exchanging a result of signal strength detection carried out by a radio wave detector included in each base station, with a different base station, and that determines a frequency to use for communications with a terminal, is described in PTL 3. A cognitive radio communication system and a database system that use a spectrum sensor (observation device) are described in PTL 4.

A radio communication system that reduces network load attributable to the sensing while maintaining the sensing accuracy of a different radio communication system, is described in PTL 5. A cognitive radio communication system that reduces the cost related to sensing, by using a white space sensing database, is described in PTL 6. An outline of the previously mentioned cognitive radio is described in NPL 1. An outline of the previously mentioned SDR is described in NPL 2.

### CITATION LIST

### Patent Literature

PTL 1: Japanese Unexamined Patent Application Publication No. 2009-171506
PTL 2: Japanese Unexamined Patent Application Publication No. 2008-252255
PTL 3: Japanese Unexamined Patent Application Publication No. 2008-079280
PTL 4: Japanese Unexamined Patent Application Publication No. 2011-188381
PTL 5: Japanese Unexamined Patent Application Publication No. 2010-258621
PTL 6: Japanese Unexamined Patent Application Publication No. 2011-176506

### Non Patent Literature

NPL 1: Hiroshi Harada, “Dai 3-kai Musen ga Kawaru! Kogunitibu Musen [3rd round, Change in Radio! Cognitive Radio]” Feb. 8, 2012 [searched on Jan. 25, 2013], Impress Business Media Corporation, Internet <URL: http://thinkit.co.jp/article/25/3/>
NPL 2: Ken Nishimura, “Sofuto Musen Jitsugen ni Ookiku Zenshin, NEC ga Yousogijyutsu Kaihatsu [Substantial progress toward implementation of Software-defined Radio—NEC developed element technology]”, Feb. 4, 2008 [searched on Jan. 25, 2013], ITmedia Inc., Internet <URL: http://www.atmarkit.co.jp/news/200802/04/nec.html>

### SUMMARY OF INVENTION

### Technical Problem

In order to cause a cognitive radio communication system to function efficiently and thereby effectively use frequency resources, it is necessary to create a database by observing, for each frequency, the state of radio wave use over a large area in each spot at each time point.

However, the following problems will be arisen in this process. First, in order to obtain highly accurate sensing results, it is necessary to use an expensive, high-performance observation device or a large number of inexpensive observation devices. Hence, the first problem is that increasing the area for which the communication system can be used requires high costs and, for this reason, expansion of the area is difficult.

Besides, the second problem is that, as a result of the above problem, frequencies need to be assigned to secondary users with excessive margins in order to protect primary users to which the frequencies are originally assigned, as a result of this, frequency use efficiency is reduced. For example, when the accuracy in frequency measurement is low, it is necessary to separate, on the frequency axis, the area for secondary use and the area for primary use more than necessary in order to protect the primary users. Further, when the accuracy in power detection is low, the system coverage area for the primary users needs to be estimated to be excessively large, which consequently limits the area in which the secondary users can use radio waves having the frequencies.

In addition to the above, when a request to newly use a radio wave having a frequency around those used by primary users in an area near those in which the primary users use the radio waves is made, known radio wave management system requires time and cost to determine whether or not the primary users can be securely protected according to the request. For this reason, the new use cannot be permitted immediately, which leads to the third problem of not advancing effective use of frequency resources.

None of the above-mentioned PTLs 1 to 6 and NPLs 1 and 2 describes a technique for solving the above-described problems and enabling us to create a database by observing states of radio wave use over a large area, at a realistically possible cost. Accordingly, it is not possible by known techniques to effectively use frequency resources while protecting primary users.

The object of the present invention is providing a radio wave observation system, a radio wave observation device, and a radio wave observation method and program that make it possible to observe states of radio wave use over a large area and create a database based thereon at a realistically possible cost.

### Solution to Problem

To achieve the above-described object, a radio wave observation system according to the present invention is characterized by including multiple radio networks each of which includes a number of terminal stations and multiple base stations and carries out radio communication between each of the terminal stations and the base station, and a central station device that is connected to the base stations, and is characterized in that each of the terminal stations includes an observation device that carries out radio wave observation when an instruction is issued by the central station device and that responds to the central station device with a result of the observation, and in that the central station device includes a storage means that includes a radio wave state database in which a radio wave state in each measurement spot is recorded, a terminal search function for identifying, for each measurement spot, a terminal station that has a current position closest to the measurement spot and is included in any one of the multiple radio networks, and a radio wave state collection function for instructing the identified terminal station to carry out radio wave observation and recording, in the radio wave state database, a result of the observation returned in response to the instruction.

To achieve the above-described object, a central station device according to the present invention that is connected, via multiple radio networks each including a number of terminal stations and multiple base stations and carrying out radio communication between each of the terminal stations and the base station, to the base stations, is characterized by including: a storage means that includes a radio wave state database in which a radio wave state in each measurement spot is recorded; a terminal search function for identifying, for each measurement spot, a terminal station that has a current position closest to the measurement spot and is included in any one of the multiple radio networks; and a radio wave state collection function for instructing the identified terminal station to carry out radio wave observation and recording, in the radio wave state database, a result of the observation returned in response to the instruction.

To achieve the above-described object, a radio wave observation method according to the present invention is characterized by including, in a radio wave observation system that includes multiple radio networks each including a number of terminal stations and multiple base stations and carrying out radio communication between each of the terminal stations and the base station, and a central station device connected to the base stations and including a radio wave state database in which a radio wave state in each measurement spot is recorded: a terminal search function of the central station device identifies a terminal station, that has a current position closest to each measurement spot and is included in any one of the multiple radio networks; a radio wave state collection function of the central station device instructs radio wave observation to the identified terminal station; upon receipt of the instruction, an observation device of the terminal station carries out radio wave observation accordingly and responding to the central station device with a result of the observation; and the radio wave state collection function of the central station device records the returned result of the observation, in the radio wave state database.

To achieve the above-described object, a radio wave observation program according to the present invention is characterized by causing, in a radio wave observation system that includes multiple radio networks and a central station device, the each of radio network including a number of terminal stations and multiple base stations and carrying out radio communication between each of the terminal stations and the base station, the central station device being connected to the base stations and including a radio wave state database in which a radio wave state in each measurement spot is recorded, a processor, included in the central station device, executing: a process of identifying, for each measurement spot, a terminal station that has a current position closest to the measurement spot and is included in any one of the multiple radio networks; a process of instructing the identified terminal station to carry out radio wave observation; and a process of recording, in the radio wave state database, a result of the observation returned in response to the instruction.

### Advantageous Effects of Invention

Since the present invention has such a configuration, in which the central station records, in the radio wave state database, all radio wave states observed by the multiple terminal stations in the radio networks as described above, it is possible to measure radio wave states over a large area by using a number of terminal stations in existing radio networks. Accordingly, it is possible to provide a radio wave observation system, a radio wave observation device, a radio wave observation method and program that have excellent characteristics of being able to observe states of radio wave use over a large area and create a database based thereon at a realistically possible cost.

### BRIEF DESCRIPTION OF DRAWINGS

FIG. 1 is an explanatory diagram illustrating a configuration of a radio wave observation system according to a fundamental exemplary embodiment of the present invention.

FIG. 2 is an explanatory diagram illustrating a configuration of a radio wave observation system according to a first exemplary embodiment of the present invention.

FIG. 3 is an explanatory diagram illustrating a concrete configuration of each train terminal station illustrated in FIG. 2.

FIG. 4 is an explanatory diagram illustrating a concrete configuration of each station-building base station device illustrated in FIG. 2.

FIG. 5 is an explanatory diagram illustrating a concrete configuration of a central station device illustrated in FIG. 2.

FIG. 6 is an explanatory table illustrating contents of a terminal database stored in a storage unit in the central station device illustrated in FIG. 5.

FIG. 7 is an explanatory table illustrating contents of a radio wave state database stored in the storage unit in the central station device illustrated in FIG. 5.

FIG. 8 is an explanatory flowchart illustrating an operation for collecting position information in the radio wave observation system illustrated in FIG. 2.

FIG. 9 is an explanatory flowchart illustrating an operation for carrying out radio wave observation in the radio wave observation system illustrated in FIG. 2.

FIG. 10 is an explanatory diagram illustrating a configuration of a radio wave observation system according to a second exemplary embodiment of the present invention.

FIG. 11 is an explanatory diagram illustrating a concrete configuration of each mobile router illustrated in FIG. 10.

FIG. 12 is an explanatory diagram illustrating a configuration of a radio wave management system according to a third exemplary embodiment of the present invention.

FIG. 13 is an explanatory diagram illustrating a more concrete configuration of a radio wave management device illustrated in FIG. 12.

FIG. 14 is an explanatory diagram illustrating a configuration of a cognitive communication system according to a fourth exemplary embodiment of the present invention.

FIG. 15 is an explanatory diagram illustrating a more concrete configuration of a radio wave management device illustrated in FIG. 14.

### DESCRIPTION OF EMBODIMENTS

### Fundamental Exemplary Embodiment

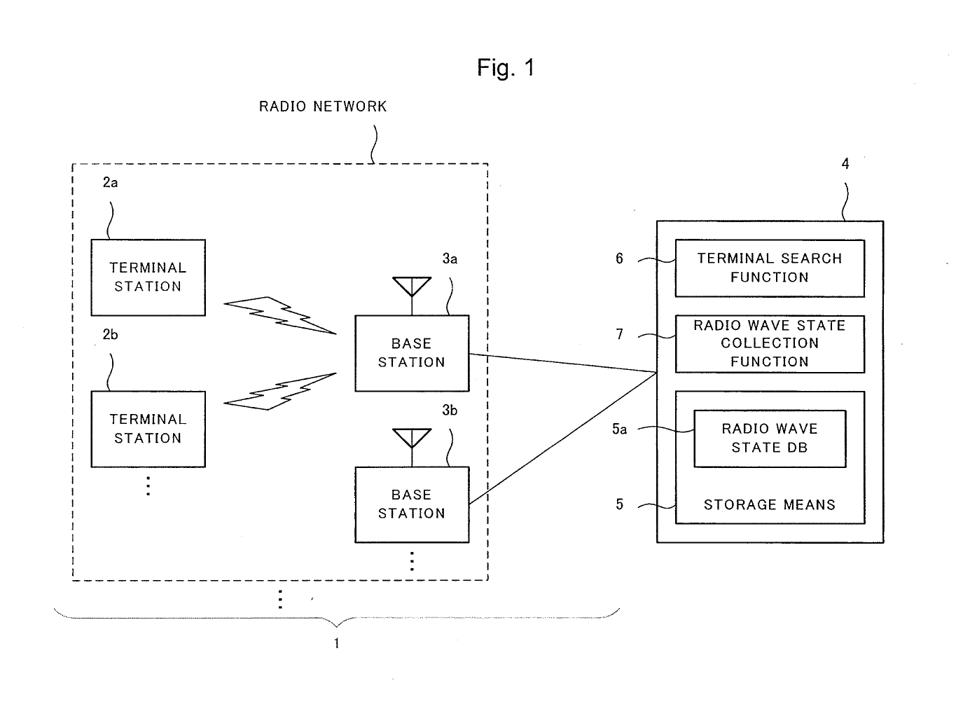

A configuration of a fundamental exemplary embodiment of the present invention is described below on the basis of attached FIG. 1.

Description first deals with basic points of the fundamental exemplary embodiment and later with more concrete points.

A radio wave observation system 1 according to the fundamental exemplary embodiment includes: multiple radio networks each including multiple base stations 3 and a number of terminal stations 2, which correspond to each of the multiple base stations 3, and carrying out radio communications between each of the terminal stations and corresponding base station; and a central station device 4, which is connected to the base stations. Each of the terminal stations 2 includes an observation device 2a, which carries out radio wave observation in response to an instruction when the instruction is received from the central station device and returns an observation result to the central station device. Besides, the central station device 4 includes a storage means 5, which includes a radio wave state database 5a, in which the radio wave state in each measurement spot is recorded, a terminal search function 6, which identifies, for each measurement spot, a terminal station that has the current position closest to the measurement spot and is included in any one of the multiple radio networks, and a radio wave state collection function 7, which instructs the identified terminal station to carry out radio wave observation and records, in the radio wave state database, the observation result returned in response to the instruction.

With this configuration, in the radio wave observation system 1, radio wave observation is carried out by each of the terminal stations 2 in the multiple radio networks, collects observation results, and stores the observation results in the radio wave state database 5a, which allows the observation results to be collectively used.

The more detailed configuration of each of the above means is described as the following exemplary embodiment.

### First Exemplary Embodiment

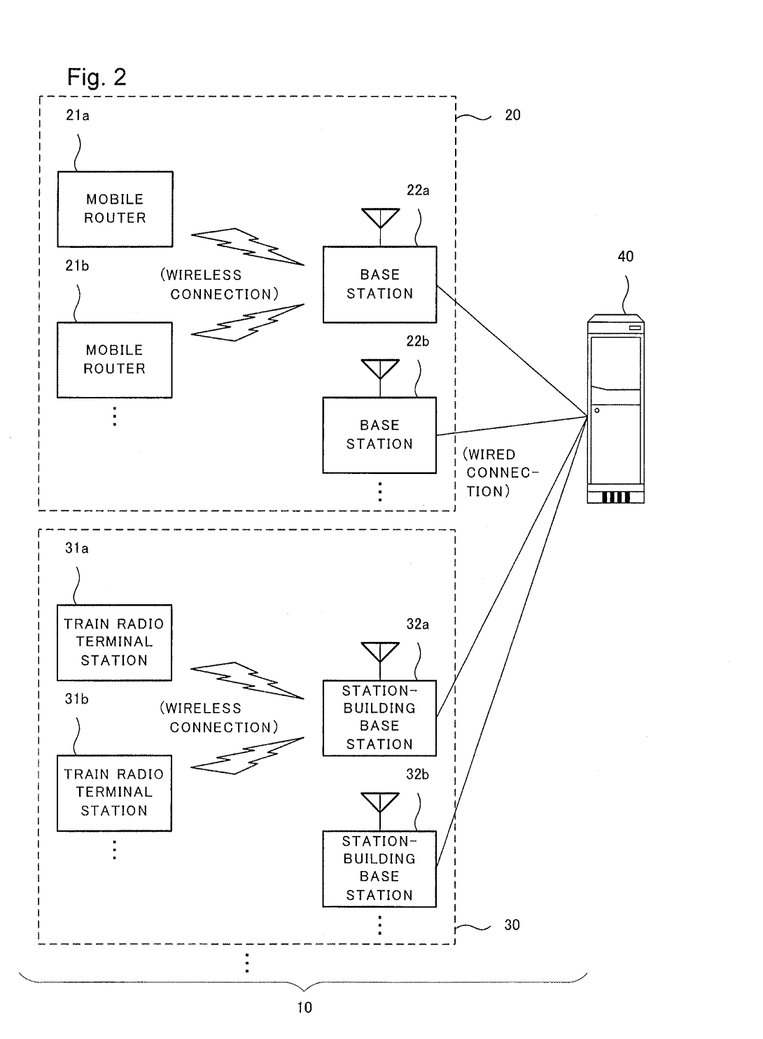

Next, a configuration of a first exemplary embodiment of the present invention is described with reference to attached FIGS. 2 to 5.

Description first deals with basic points of this exemplary embodiment and later with more concrete points thereof.

A radio wave observation system 10 according to this exemplary embodiment includes: multiple radio networks (cellular network(s) 20 or train radio communication network(s) 30), each of which includes multiple base stations (base stations 22 or station-building base stations 32) and a number of terminal stations (mobile routers 21 or train terminal stations 31) corresponding to each of the multiple base stations, and each of which carries out radio communications between each of the terminal stations and the base station; and a central station device 40, which is connected to the base stations. Each of the terminal stations 21 (31) includes an observation device 104, which carries out radio wave observation when an instruction is issued from the central station device and returns an observation result to the central station device. Besides, the central station device 40 includes: a storage means (storage unit 42), which includes a radio wave state database 322, in which a radio wave state in each measurement spot is recorded; a terminal search function 314b for identifying, for each measurement spot, a terminal station that has the current position closest to the measurement spot and is included in any one of the multiple radio networks; and a radio wave state collection function 314c for instructing the identified terminal station to carry out radio wave observation and recording, in the radio wave state database 322, the observation result returned in response to the instruction.

Further, the terminal search function 314b of the central station device 40 searches a terminal database 321, which is stored in the storage means and in which the current position of each terminal station is recorded, and identifies the terminal station that has the current position closest to the measurement spot. Besides, the observation device 104 of each of the terminal stations 21 (31) includes a position acquisition unit 104d, which acquires the current position of the terminal station 21 (31), and the central station device 40 includes a position information collection function 314a for regularly acquiring the current position from each terminal station and storing the current position in the terminal database 321.

With the above configuration, the radio wave observation system 10 collects the observation results of the radio wave observations carried out by a number of terminal stations 21 (31) in the multiple radio networks and stores the observation results in the radio wave state database 322. Thus, observing states of radio wave use over a large area, and then, creating a database based thereon at a realistically possible cost are enabled.

This is described below in more detail.

FIG. 2 is a diagram illustrating a configuration of the radio wave observation system 10 according to the first exemplary embodiment of the present invention. The radio wave observation system 10 has a configuration in which the cellular network (public radio communication network) 20 and the train radio communication network 30 are integrated via the central station device 40. This configuration is provided as an example, and the radio wave observation system 10 may obviously be one in which three or more kinds of radio communication networks are integrated or one in which one of or both the cellular network 20 and the train radio communication network 30 are replaced with different communication networks.

The cellular network 20 includes a number of mobile routers 21a, 21b, . . . and multiple base stations 22a, 22b, . . . . In the following description, these are collectively referred to as mobile routers 21 and base stations 22, respectively. Each of the mobile routers 21 and the corresponding base station 22 communicate with each other by way of public radio communications. Each of the base stations 22 and the central station device 40 are connected to each other via a wired line.

The train radio communication network 30 includes a number of train terminal stations 31a, 31b, . . . , which are installed in respective trains, and station-building base stations 32a, 32b, . . . , which are installed in respective stations. In the following description, these are collectively referred to as train terminal stations 31 and station-building base stations 32, respectively. Each of the train terminal stations 31 and the corresponding station-building base station 32 communicate with each other by way of train radio communications. Each of the station-building base stations 32 and the central station device 40 are connected to each other via a wired line.

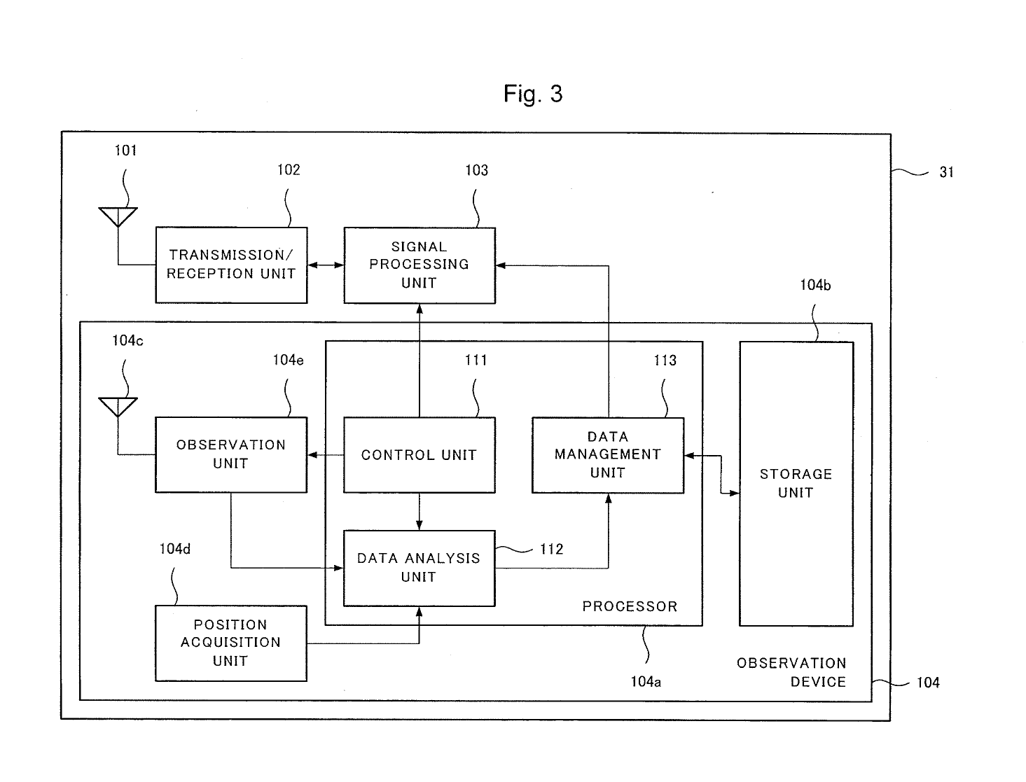

FIG. 3 is a diagram illustrating a concrete configuration of the train terminal stations 31 illustrated in FIG. 2. Each of the train terminal stations 31 includes an antenna 101, a transmission/reception unit 102, and a signal processing unit 103, which are originally included in a train radio system, and the observation device 104, which is additionally included for radio wave observation according to the present invention. Note that the configuration of the mobile routers 21 is basically the same as that of the train terminal stations 31.

The antenna 101 transmits and receives radio waves used in the train radio system, to and from the corresponding station-building base station 32. The transmission/reception unit 102 generates a radio signal to be transmitted via the antenna 101 and converts a radio signal received by the antenna 101 to a baseband signal. The signal processing unit 103 carries out a baseband process and an application process for transmitting and receiving a radio signal.

The observation device 104 includes: a processor 104a, which is a main unit for executing a computer program; a storage unit 104b, which stores data; a broadband antenna 104c, which receives radio signals; the position acquisition unit 104d, which acquires the current position of the train terminal station 31 through communications with the GPS (global positioning system) and the corresponding station-building base station; and an observation unit 104e, which measures the strength of a radio signal received by the broadband antenna 104c.

The processor 104a functions as each of a control unit 111, a data analysis unit 112, and a data management unit 113 according to control based on the computer program. The data analysis unit 112 analyzes observation data by combining a radio wave strength observed by the observation unit 104e with the current position acquired by the position acquisition unit 104d and the current time point. The data management unit 113 performs management such as update, compression, and deletion of the data held in the storage unit 104b.

The control unit 111 controls the operation of each of the transmission/reception unit 102, the signal processing unit 103, the position acquisition unit 104d, the observation unit 104e, and the data analysis unit 112 on the basis of a received control signal used for radio wave observation in the train radio system.

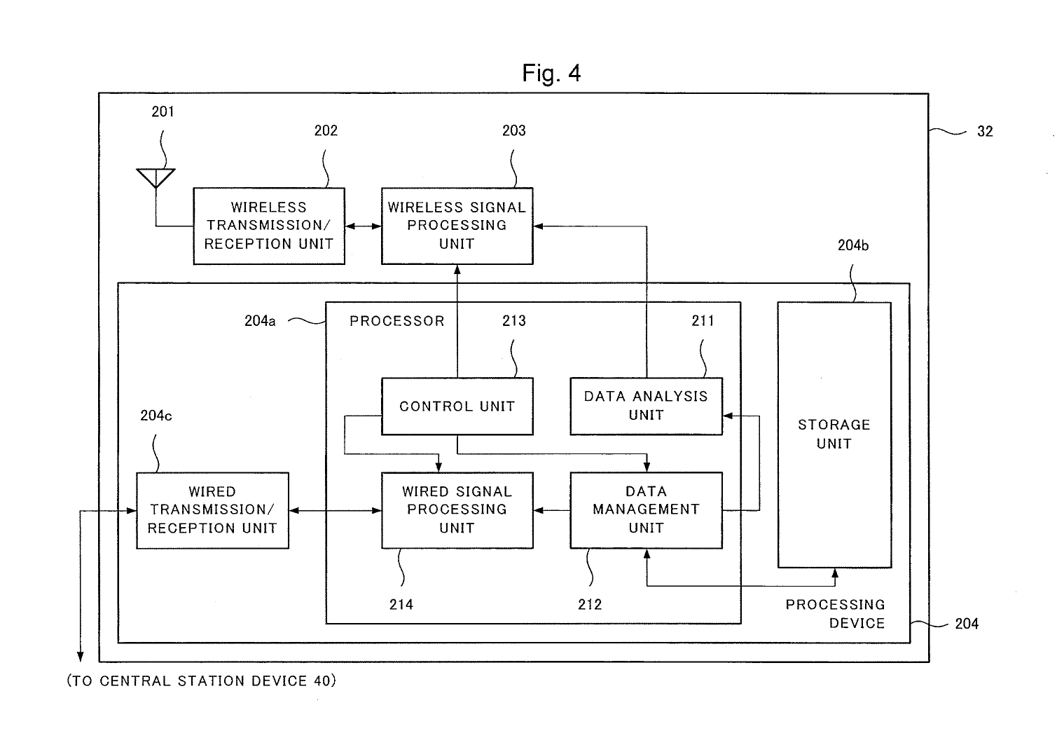

FIG. 4 is a diagram illustrating a concrete configuration of the station-building base stations 32 illustrated in FIG. 2. Each of the station-building base stations 32 includes an antenna 201, a transmission/reception unit 202, and a wireless signal processing unit 203, which are originally included in the train radio system, and a processing device 204, which is additionally included for radio wave observation according to the present invention. Note that the configuration of the base stations 22 is basically the same as that of the station-building base stations 32.

The antenna 201 transmits and receives radio waves used in the train radio system, to and from the train terminal stations 31. The wireless transmission/reception unit 202 generates a radio signal to be transmitted via the antenna 201 and converts a radio signal received by the antenna 201 to a baseband signal. The wireless signal processing unit 203 carries out a baseband process and an application process for transmitting and receiving a radio signal.

The processing device 204 includes: a processor 204a, which is a main unit for executing a computer program, a storage unit 204b, which stores data, and a wired transmission/reception unit 204c, which transmits and receives data to and from the central station device 40.

The processor 204a functions as each of the data analysis unit 211, the data management unit 212, the control unit 213, and a wired signal processing unit 214 according to control using the computer program. The data analysis unit 211 analyzes observation data output by the signal processing unit 203. The data management unit 212 performs management such as update, compression, and deletion of data held in the storage unit 204b.

The observation data held in the storage unit 204b is transmitted to the central station device 40 via the wired line, by operations of the transmission/reception unit 204c and the signal processing unit 214. The wired transmission/reception unit 204c and the wired signal processing unit 214 receive a control signal from the central station device 40 and output the control signal to the control unit 213. The control unit 213 controls the wireless transmission/reception unit 202, the wireless signal processing unit 203, the wired signal processing unit 214, and the data analysis unit 211 on the basis of a control signal from the central station.

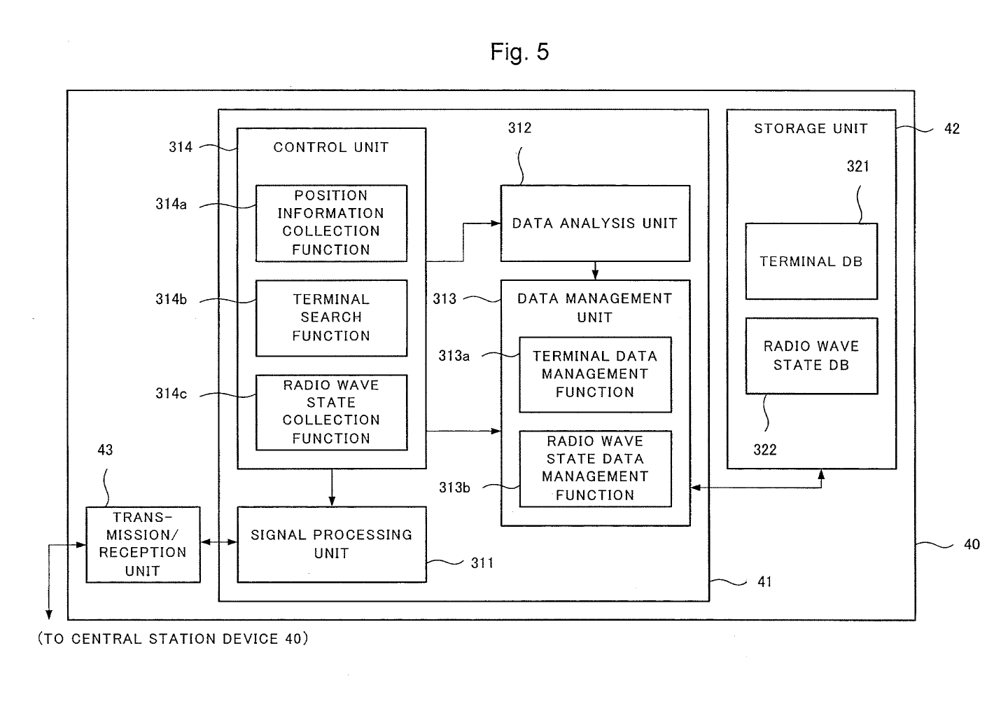

FIG. 5 is a diagram illustrating a concrete configuration of the central station device 40 illustrated in FIG. 2. The central station device 40 includes: a processor 41, which is a main unit for executing a computer program; a storage unit 42, which stores data; and a transmission/reception unit 43, which transmits and receives data to and from the station-building base stations 32.

The processor 41 functions as each of a signal processing unit 311, a data analysis unit 312, a data management unit 313, and the control unit 314 according to control based on the computer program. The transmission/reception unit 43 and the signal processing unit 311 transmit a control signal to the station-building base stations 32 and receive observation data from each of the station-building base stations 32 via a wired line. The data analysis unit 312 analyzes observation data output by the signal processing unit 311.

The data management unit 313 performs management such as update, compression, and deletion of the data held in the storage unit 42. The functions of the data management unit 313 include a terminal database management function 313a and a radio wave state database management function 313b. The storage unit 42 includes storage areas such as the terminal database 321 and the radio wave state database 322, and the terminal database management function 313a and the radio wave state database management function 313b manage the data stored in the respective storage areas.

The control unit 314 controls the observation device 104 of each of the train terminal stations 31 and the processing device 204 of each of the station-building base stations 32. The functions of the control unit 314 include the position information collection function 314a, the terminal search function 314b, and the radio wave state collection function 314c. The operations of the respective functions are described later.

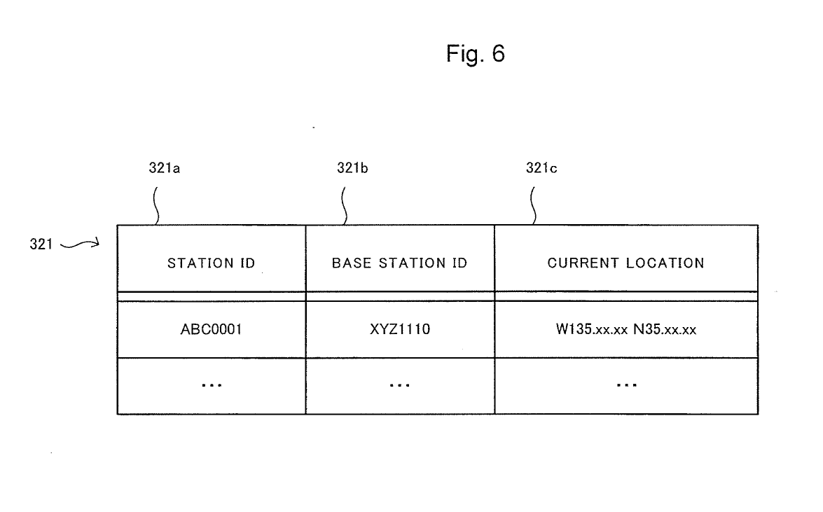

FIG. 6 is a table illustrating contents of the terminal database 321 stored in the storage unit 42 in the central station device 40 illustrated in FIG. 5. The terminal database 321 includes, for each of the mobile routers 21 or the train terminal stations 31, at least data such as: a station ID 321a, which can uniquely identify the station; a base station ID 321b, which identifies the base station 22 or the station-building base station 32 controlling the station; and a current location 321c, which indicates the current location of the station. The current location 321c may be the combination of the latitude and the altitude or the name of a landmark, same as a measurement spot 322a of the radio wave state database 322 to be described later.

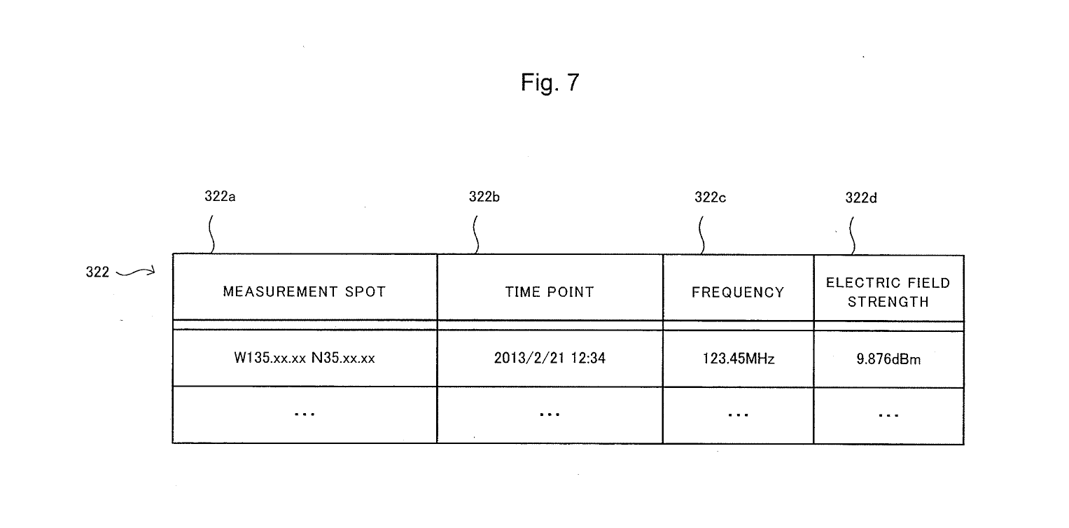

FIG. 7 is a table illustrating contents of the radio wave state database 322 stored in the storage unit 42 in the central station device 40 illustrated in FIG. 5. The radio wave state database 322 includes at least data such as the measurement spot 322a, a time point 322b, a radio wave frequency 322c and an electric field strength 322d corresponding to the spot and the time point. The measurement spot 322a may be the combination of the latitude and the altitude indicating the spot on the basis of a GPS signal, or the name of the landmark of the spot. Further, the radio wave state database 322 may include, in addition to the above, information on the frequency bandwidth and the direction of each radio wave measurement.

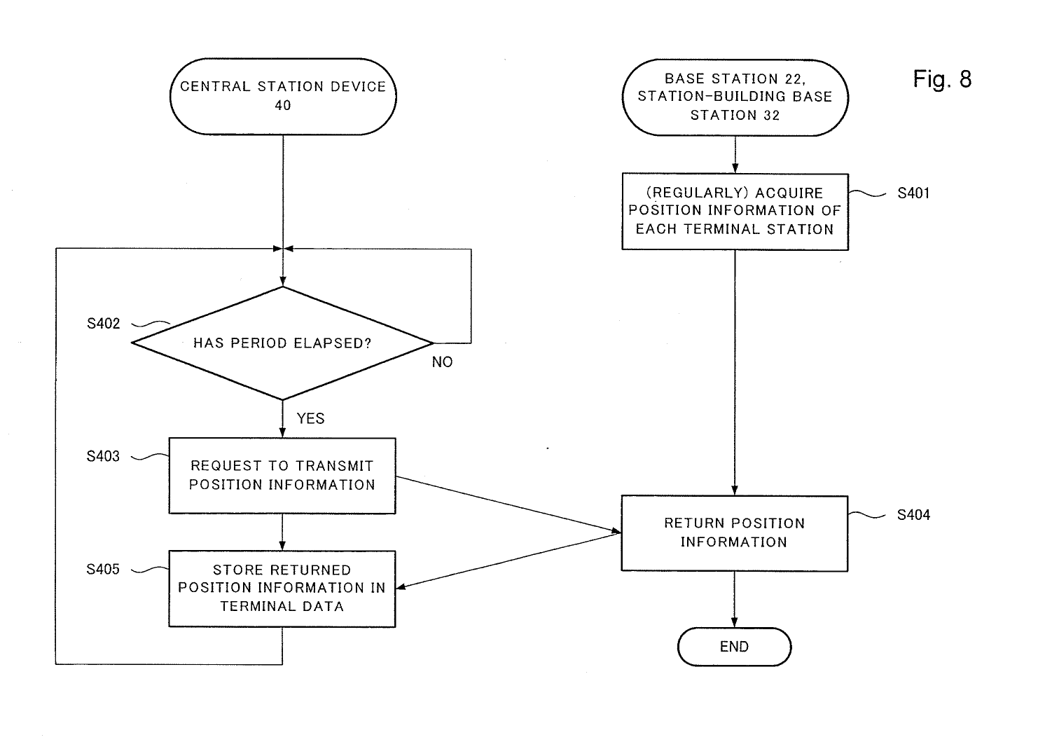

FIG. 8 is a flowchart illustrating an operation performed when the radio wave observation system 10 illustrated in FIG. 2 collects position information. Each of the cellular network 20 and the train radio communication network 30 carries out usual information communications in the communication network when not carrying out radio wave observation. In the cellular network 20, each of the base stations 22 regularly collects position information on each of the corresponding mobile routers 21 and performs an update when appropriate. Similarly, in the train radio communication network 30, each of the station-building base stations 32 regularly collects position information on each of the train terminal stations 31 and performs an update when appropriate (Step S401).

Every time a predetermined period has elapsed (Step S402), the position information collection function 314a requests each of the base stations 22 and the station-building base stations 32 to transmit the position information (Step S403) and stores the position information returned in response to the request (Step S404), in the terminal database 321 via the terminal database management function 313a (Step S405).

This operation may be performed in each predetermined period as illustrated in FIG. 8 or may be performed in a way that, every time the base station 22 or the station-building base station 32 controlling the station changes (a so-called handover is performed) as a result of physical move of the mobile router 21 or the train terminal station 31, the base station 22 or the station-building base station 32 reports the change.

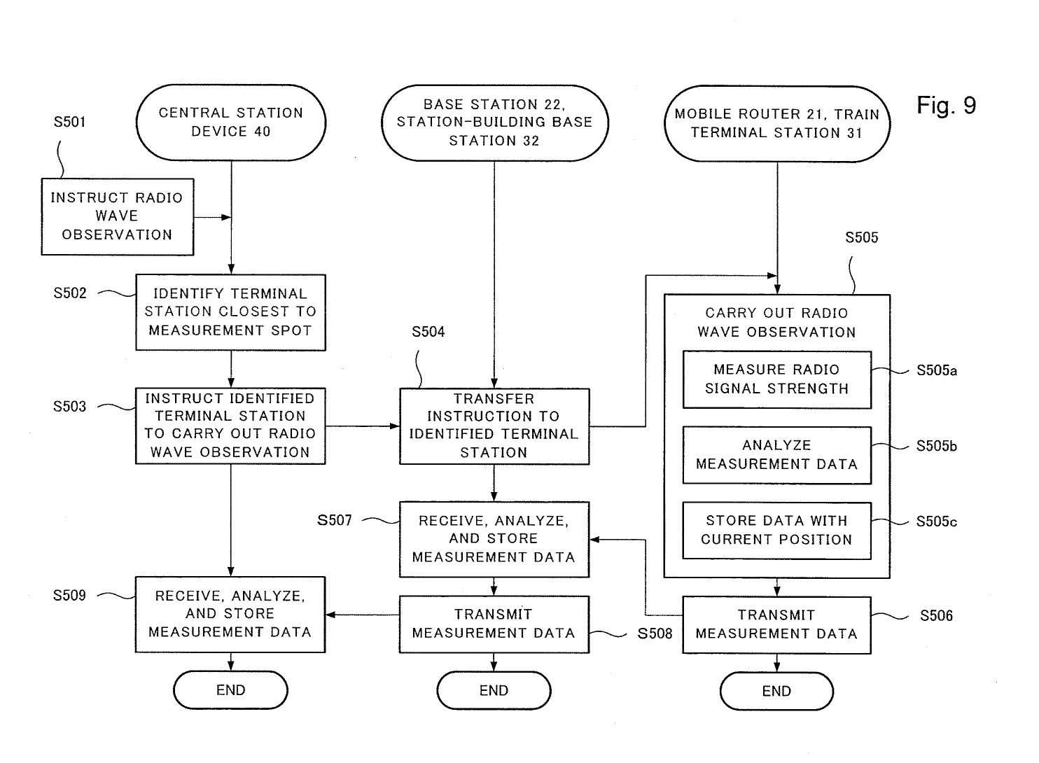

FIG. 9 is a flowchart illustrating an operation performed when the radio wave observation system 10, illustrated in FIG. 2, carries out radio wave observation. Here, it is assumed that an instruction to carry out radio wave observation at a certain measurement spot has been issued to the central station device 40 (Step S501). This instruction may be directly input to an input terminal included in the central station device 40 or may be transmitted from a different device. Alternatively, this operation may be regularly and automatically started by a timer built in the central station device 40 or the like.

Upon receipt of this instruction, the terminal search function 314b of the control unit 314 searches the terminal database 321 via the terminal database management function 313a and identifies the station ID 321a of the mobile router 21 or the train terminal station 31 that has the current location 321c closest to the measurement spot, and the base station ID 321b that identifies the base station 22 or the station-building base station 32 controlling the station (Step S502).

Thereafter, the radio wave state collection function 314c instructs the base station 22 or the station-building base station 32 corresponding to the base station ID 321b, to transmit a radio wave observation instruction to the mobile router 21 or the train terminal station 31 corresponding to the station ID 321a (Step S503). This radio wave observation instruction includes information such as the time point, place, frequency band, bandwidth, and direction according to which radio wave observation is to be carried out.

Upon receipt of the radio wave observation instruction, the base station 22 or the station-building base station 32 transfers the instruction to the corresponding mobile router 21 or train terminal station 31 (Step S504). Then, upon receipt of the transferred radio wave observation instruction, the mobile router 21 or the train terminal station 31 carries out radio wave observation according to the instruction (Step S505).

More specifically, the control unit 111 issues a measurement instruction to the observation unit 104e, and, in response to the instruction, the observation unit 104e measures the strength of a radio signal received by the broadband antenna 104c (Step S505a). Then, the data analysis unit 112 analyzes the measurement data (Step S505b), and the data management unit 113 stores the analysis data together with the current position acquired by the position acquisition unit 104d, in the storage unit 104b after data compression or the like when appropriate (Step S505c).

Then, the control unit 111 transmits the data to the base station 22 or the station-building base station 32 via the signal processing unit 103, the transmission/reception unit 102, and the antenna 101 (Step S506). In the base station 22 or the station-building base station 32, the data analysis unit 211 further analyzes the data received via the signal processing unit 203, and the data management unit 212 stores the obtained data in the storage unit 204b after data compression or the like when appropriate (Step S507). Then, the control unit 213 transmits the data to the central station device 40 (Step S508).

The “analysis” performed here may be a process for reducing data amount by carrying out a statistical process for obtaining the maximum value, the minimum value, the average value, or the standard deviation, on the measurement data chronologically output by the observation unit 104e, or a process for calculating the proportion of the time period in which the frequency band is occupied. This process may or may not be carried out.

Alternatively, this process may be carried out by the data analysis unit 112 of the mobile router 21 or the train terminal station 31, or may be carried out by the data analysis unit 211 of the base station 22 or the station-building base station 32. The process may obviously be carried out by the central station device 40. In short, the device, the stage, and the degree may be determined appropriately for the process according to the conditions such as the throughput of each device and the amount of data to be transmitted.

In the central station device 40, the radio wave state collection function 314c receives data received from the base station 22 or the station-building base station 32, and the radio wave state database management function 313b stores the data, for which an analysis process is carried out when appropriate, in the radio wave state database 322 (Step S509). The data stored in the radio wave state database 322 can be fetched in response to an inquiry appropriately made to the central station device 40 by a different computer or the like.

### Entire Operation of Exemplary Embodiment

Next, the entire operation of the above-described exemplary embodiment is described.

In a radio wave observation method according to this exemplary embodiment, in the radio wave observation system, which includes the multiple radio networks 20 (30) each including the multiple base stations 22 (32) and a number of terminal stations 21 (31) corresponding to each of the multiple base stations 22 (32) and carrying out radio communications between each of the terminal stations and the corresponding base station, and the central station device 40 connected to the base stations and storing the radio wave state database 322 in which the radio wave state in each measurement spot is recorded, the terminal search function of the central station device identifies, for each measurement spot, the terminal station that has the current position closest to the measurement spot and is included in any one of the multiple radio networks (Step S502 in FIG. 9), the radio wave state collection function of the central station device instructs the identified terminal station to carry out radio wave observation (Step S503 in FIG. 9), the observation device of the terminal station carries out radio wave observation in response to the instruction (Steps S504 to 505 in FIG. 9) and returns an observation result to the central station device (Step S506 in FIG. 9), and the radio wave state collection function of the central station device records the returned observation result in the radio wave state database (Step S509 in FIG. 9).

Further, the position information collection function of the central station device regularly acquires the current position of each terminal station acquired by the position acquisition unit originally included in the terminal station and records the acquired current position in the terminal database (steps S402 to 405 in FIG. 8). The terminal search function of the central station device identifies the terminal station that has the current position closest to the measurement spot by searching the terminal database (Step S502 in FIG. 9).

Here, the above-described operation steps may be programmed in a computer-executable manner and executed by the processor 41 which is included in the central station device 40 and directly executes the steps. The program may be recorded in a nonvolatile recording medium such as a DVD, a CD, or a flash memory, for example. In this case, the program is read from the recording medium and executed by a computer.

Through this operation, this exemplary embodiment exerts the following effects.

According to the radio wave observation system 10 of this exemplary embodiment, radio wave states measured by a number of terminal stations (the mobile routers 21 and the train terminal stations 31) included in different communication networks, i.e., the cellular network 20 and the train radio communication network 30, are all collected in a single database, i.e. the radio wave state database 322, so as to be usable when appropriate. This enables to obtain information that is very useful from the viewpoint of effective use of frequency resources, in a realistically possible manner, while protecting primary users.

The radio wave observation system 10, described above, has the configuration in which the cellular network 20 and the train radio communication network 30 are integrated via the central station device 40. However, as mentioned previously, this configuration is provided as an example. The radio wave observation system may be one in which three or more kinds of radio communication networks are integrated or may be one in which one of or both the cellular network 20 and the train radio communication network 30 are replaced with different communication networks.

For example, as a terminal station, a mobile unit such as a private car, a bus, a taxi, a garbage truck, a police vehicle, an ambulance, a fire truck, a ship, a helicopter, or an airplane, other than a train may be used. Alternatively, smartphones, access points such as Wi-Fi (wireless LAN) access points, and micro cellular base stations may be used.

Further, each terminal station may be further connected to a different network. For example, a low-power radio sensor network employing a low-power radio standard such as a ZigBee (registered trademark) or a Bluetooth (registered trademark), for example, may be connected to a smartphone. This means that a low-power radio sensor network may be connected to a central station via a smartphone and a microcell base station, and means also that the central station can control a low-power radio sensor network node.

Besides, not all terminal stations need to be connected to the base stations (the base stations 22 or the station-building base stations 32). A network configuration in which terminal stations communicate with each other and are indirectly connected to the base stations by way of multihop transmission may be employed. Alternatively, each terminal station may be directly connected to a wired network. In this case, base stations may be omitted.

Further, each base station may include an observation device. Since a base station can include a larger-scale observation device than that for a terminal station in general, this configuration enables more accurate and highly sensitive observation. Besides, a communication means between each base station and the central station may be a wired or wireless communication means, or may be a means in which data held in each of the base station and the central station is temporarily stored in an external storage (such as a USB flash memory, for example) and a person moves data from one to the other.

Further, the observation devices installed in the respective terminal stations may be devices having the same characteristics or devices having different characteristics. For example, the terminal stations may include respective observation devices specialized in different frequency bands, and observation results from the observation devices may be combined, so that a wide frequency band is covered. In this case, it is necessary to collect, in addition to the position information of each terminal station, information on the frequency band in which the terminal station can measure and to store the information in the terminal database in advance.

The operation performed when a single terminal station carries out radio wave observation is described with reference to FIGS. 8 and 9. However, it is easy to make it possible for multiple terminal stations to simultaneously carry out radio wave observation by this operation. Through this operation, the results obtained in a way that multiple terminal stations in multiple communication networks carry out radio wave observation for radio waves having the same frequency band can be all stored in the radio wave state database 322 in the central station device 40, and a more accurate radio wave observation result can be obtained by analyzing the stored results. In addition, a correlational analysis between observation data of the respective communication networks is also possible.

In this case, the timing at which an observation instruction is transmitted to a terminal station or an observation result is returned in response to the instruction may be shifted for each terminal station or each communication network. In this way, it is also possible to reduce congestion occurring when a large amount of information is transmitted all at once and an excessive increase of the load at the central station device to which the information is transmitted.

Further, a radio wave transmission function that each of the mobile routers 21 or the train terminal stations 31 originally has transmits radio waves according to conditions such as a certain frequency, strength, and direction at a certain time point, and, at the same time, each of the terminal stations observes the radio waves. This enables to find out the transmission state of the radio waves and to evaluate an influence and the like of the radio waves on the surrounding environment, which consequently enables the use of the evaluation result for the purpose of optimizing the transmission output power of each train radio terminal station depending on an area and the like for saving energy.

In general, the magnitude of a radio wave output that a terminal station can transmit is limited. For this reason, radio waves transmitted by a terminal station (first terminal station) may not be received by a different terminal station (second terminal station) located at a place that is certain distance away from the first terminal station. In such a case, it is possible to carry out simulation evaluation by using a third terminal station, which is located between the first and second terminal stations.

More concretely, the third terminal station receives radio waves having a certain frequency which are transmitted by the first terminal station and calculates transmission loss from the received radio waves. Similarly, the second terminal station receives radio waves having the same frequency which are transmitted by the third terminal station and calculates transmission loss from the received radio waves. The “transmission loss between the first terminal station and the second terminal station” can be calculated on the basis of the “transmission loss between the first terminal station and the third terminal station”, the “transmission loss between the third terminal station and the second terminal station”, and the position information of each station.

In this case, two or more terminal stations or base stations may be interposed. Alternatively, multiple terminal stations or base stations simultaneously receive radio waves from a single terminal station or base station, and transmission loss may be calculated. This enables to estimate an influence on a spot at which no observation device can exist (e.g., an area other than the railroad on which a train travels, in the case of a train radio communication network).

### Second Exemplary Embodiment

A radio wave observation system 610 according to a second exemplary embodiment of the present invention has a configuration in which each terminal station (mobile router 621) includes a transmission unit (SDR transmission unit 704f) which transmits radio waves according to the conditions instructed by the central station device, in addition to the configuration of the first exemplary embodiment.

With the above configuration, it is possible to transmit radio waves having a frequency or being based on a modulation scheme that is not originally supported by the terminal station, in addition that the same effects as those of the first exemplary embodiment can be obtained, which enables measurement of more detailed radio wave states.

This is described below in more detail.

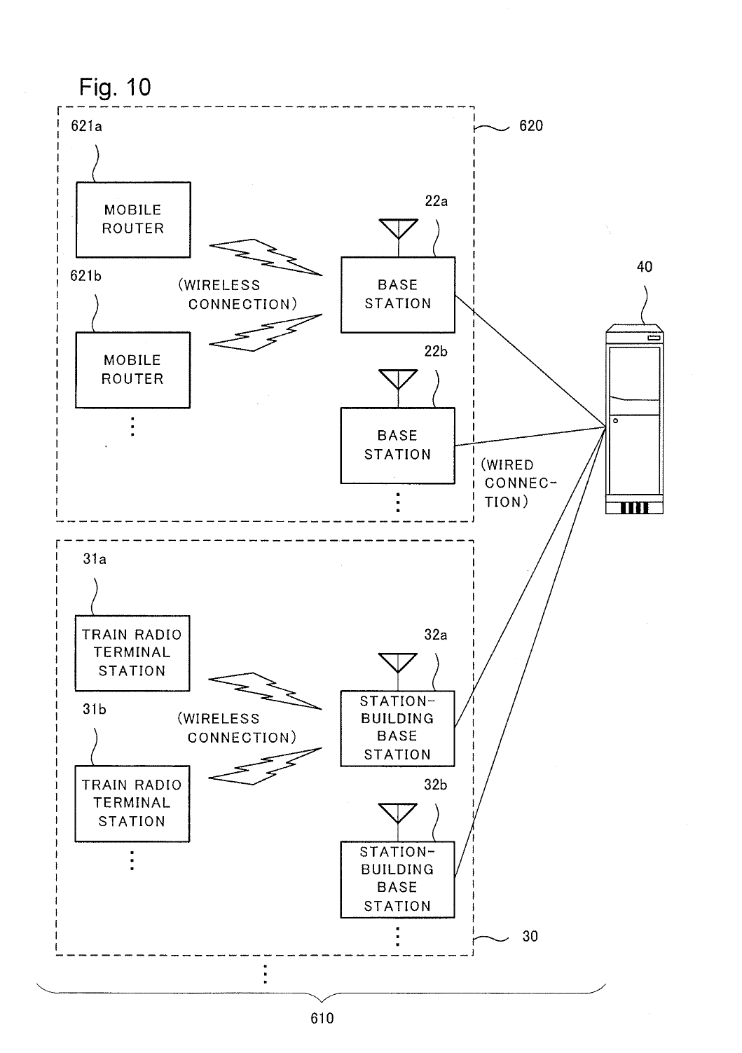

FIG. 10 is a diagram illustrating a configuration of the radio wave observation system 610 according to the second exemplary embodiment of the present invention. In comparison with the above-described radio wave observation system 10 according to the first exemplary embodiment, in the radio wave observation system 610, the cellular network 20 is replaced with a different cellular network 620. This cellular network 620 has a configuration in which mobile routers 621, which are different from the mobile routers 21 according to the first exemplary embodiment, and the base stations 22, which are the same as those of the first exemplary embodiment, communicate with each other by way of public radio communications.

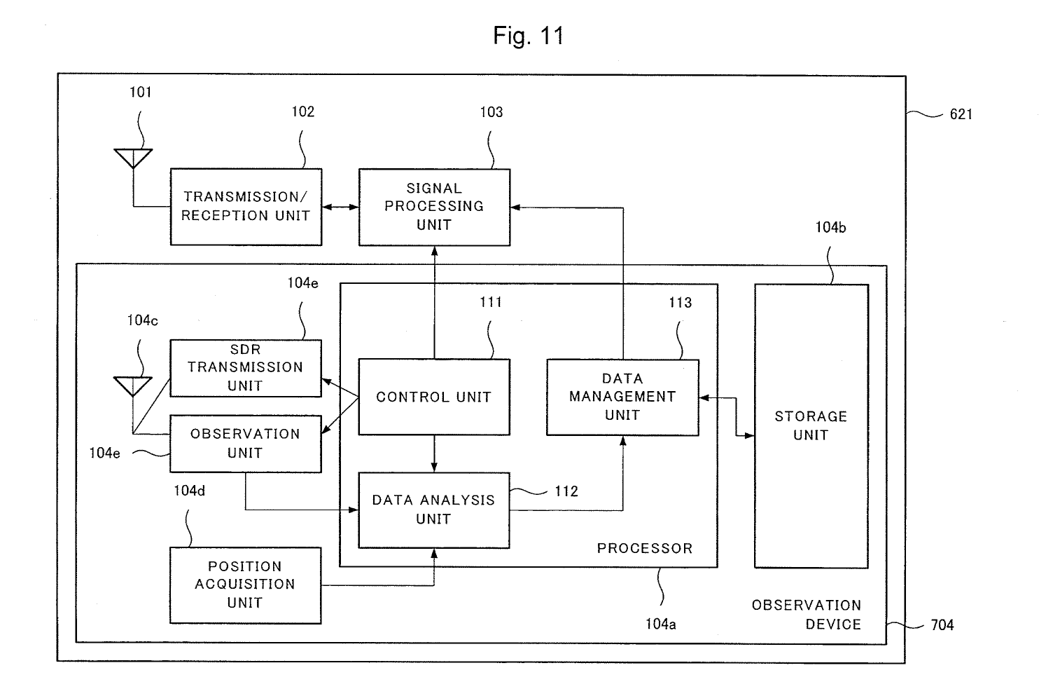

FIG. 11 is a diagram illustrating a concrete configuration of the mobile routers 621 illustrated in FIG. 10. In comparison with the mobile routers 21 according to the first exemplary embodiment, the mobile routers 621 have a configuration in which the observation device 104 is replaced with a different observation device 704.

In comparison with the observation device 104 according to the first exemplary embodiment, to the observation device 704, the SDR transmission unit 704f, which transmits radio waves to a different device in a specified frequency band, modulation scheme, and output power by way of the SDR (software-defined radio) described in the section of Background Art, is added.

In addition to the above, the observation unit 104e is replaced with a different observation unit 704e, and the control unit 111 and the data analysis unit 112 operated in the processor 104a are further replaced respectively with a different control unit 711 and a different data analysis unit 712. The control unit 711 additionally has the function of instructing, for example, a frequency band, modulation scheme, and output power for transmitting radio waves to the SDR transmission unit 704f. Besides, the observation unit 704e and the data analysis unit 712 function as an SDR reception unit that receives radio waves in the frequency band and modulation scheme specified by the instruction from the control unit 711.

With this configuration, the mobile routers 621 can transmit and receive as well as measure radio waves having a frequency and being based on a modulation scheme that is used only by the train radio communication network 30. Obviously, a configuration in which an SDR transmission unit is added to each terminal station (such as each train terminal station) other than each mobile router may be employed. Further, with this configuration, it is easily possible to integrate networks different from the cellular network and the train radio communication network in the radio wave observation system.

### Third Exemplary Embodiment

A radio wave observation system 810 according to a third exemplary embodiment of the present invention has a configuration in which a radio wave management device 850, which monitors illegal radio waves and manages radio wave users by using the radio wave state database 322 recorded in the central station device 40, is added to the configuration of the first exemplary embodiment.

With the above configuration, it is possible to manage radio wave use on the basis of actually measured radio wave states, in addition that the same effects as those of the first exemplary embodiment can be obtained.

This is described below in more detail.

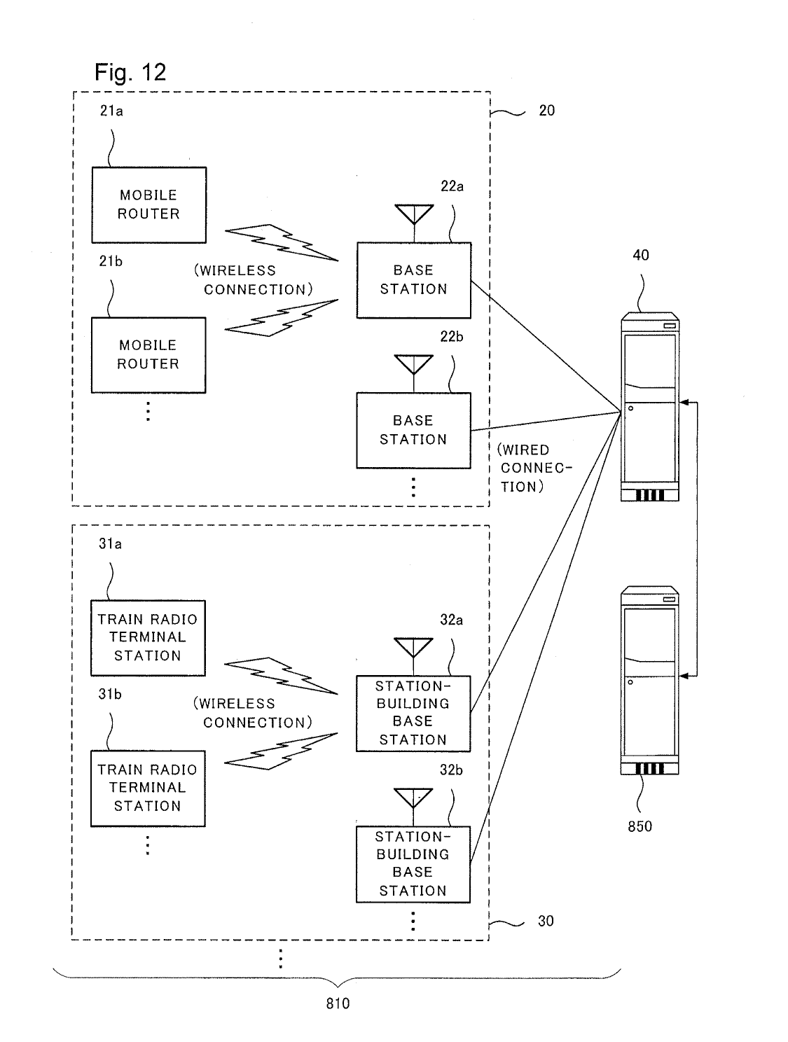

FIG. 12 is a diagram illustrating a configuration of the radio wave management system 810 according to the third exemplary embodiment of the present invention. The radio wave management system 810 further uses, for the management of states of radio wave use, the radio wave state database 322 recorded in the central station device 40 in the radio wave observation system 10 according to the first exemplary embodiment or the radio wave observation system 610 according to the second exemplary embodiment described above. In other words, the radio wave management system 810 has a configuration in which the radio wave management device 850 is additionally connected to the central station device 40. This connection may be wired or wireless.

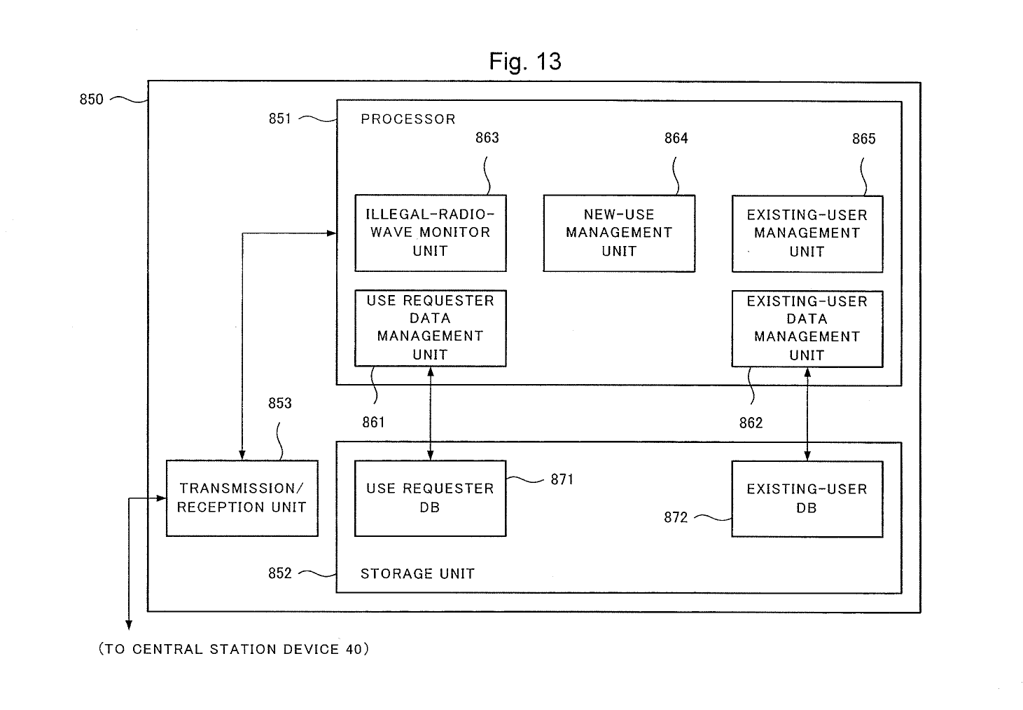

FIG. 13 is a diagram illustrating a more concrete configuration of the radio wave management device 850 illustrated in FIG. 12. The radio wave management device 850 includes a processor 851, which is a main unit for executing a computer program, a storage unit 852, which stores data, and a transmission/reception unit 853, which transmits and receives data to and from the central station device 40.

The processor 851 functions as each of a use requester data management unit 861, an existing-user data management unit 862, an illegal-radio-wave monitor unit 863, a new-use management unit 864, and an existing-user management unit 865. The storage unit 852 includes storage areas such as a use requester database 871 and an existing-user database 872, and the use requester data management unit 861 and the existing-user data management unit 862 manage the data stored in the respective storage areas.

The use requester database 871 holds, for each requester who desires to newly use radio waves, information such as the area, period, the frequency band, the bandwidth to be occupied, the power, and the priority that are desired to use. The priority may be decided on the basis of information such as the timing of the request, the importance of the communications, and the use efficiency of the frequencies if the use is permitted. The use requester data management unit 861 adds, edits, and deletes information such as the examples above according to a request by a use requester.

The existing-user database 872 holds information such as the area, period, frequency band, bandwidth to be occupied, and power for each user permitted to use radio waves. The existing-user data management unit 862 adds, edits, and deletes information such as the above according to a request by a user.

The illegal-radio-wave monitor unit 863 detects whether or not radio waves not registered in the existing-user database 872 are recorded in the radio wave state database 322 by comparing the contents of the radio wave state database 322 recorded in the central station device 40 and the contents of the existing-user database 872. If such radio waves are found, the illegal-radio-wave monitor unit 863 determines that the radio waves may originate in an illegal radio wave station and outputs information on the corresponding area and frequency band. Alternatively, the illegal-radio-wave monitor unit 863 may instruct the central station device 40 to collect more detailed information on the area.

The new-use management unit 864 evaluates whether or not existing communications and the like are negatively affected if communications are carried out according to the desired area, period, frequency band, bandwidth to be occupied, and power registered in the use requester database 871, by comparing the contents of the existing-user database 872 and the contents of the radio wave state database 322. If it is determined that “no particular negative influence occurs” as a result of the evaluation, the new-use management unit 864 outputs a response indicating that “permission may be given” to the new use.

The new-user management unit 864 may have a configuration of being capable of indicating, if it is determined that “no particular negative effect occurs” as a result of the evaluation, an option of changing the frequency band, bandwidth to be occupied, power, and the like so that the negative influence would not occur. Alternatively, the new-user management unit 864 may instruct the central station device 40 to evaluate the influence by actually transmitting radio waves in the requested frequency band, bandwidth to be occupied, and power.

The existing-user management unit 865 compares the contents of the radio wave state database 322 recorded in the central station device 40 and the contents of the existing-user database 872, and detects whether or not communications different from the contents that are permitted are carried out, for example, an existing user is transmitting radio waves with a power equal to or higher than that permitted for the user to use or an existing user has not transmitted radio waves with a permitted power in a long time period.

If radio waves are transmitted with a power equal to or higher than a permitted power, warning may be given to the user. Besides, frequencies that are not used or used at a low frequency may be provided for secondary use for new-use requesters, in cooperation with the new-use management unit 864.

### Fourth Exemplary Embodiment

A radio wave observation system (cognitive communication system 910) according to a fourth exemplary embodiment of the present invention has a configuration in which a radio wave management device 950 is connected to a cognitive communication network 920 for carrying out cognitive communications and includes a communication condition decision unit 966, which decides a usable communication condition on the basis of a radio wave state database and transmits the communication condition to the cognitive communication network, in addition to the configuration of the third exemplary embodiment.

With the above configuration, it is possible to effectively use frequency resources by deciding communication conditions on the basis of actually measured radio wave states and carrying out communications accordingly, in addition that the same effects as those of the third exemplary embodiment can be obtained.

This is described below in more detail.

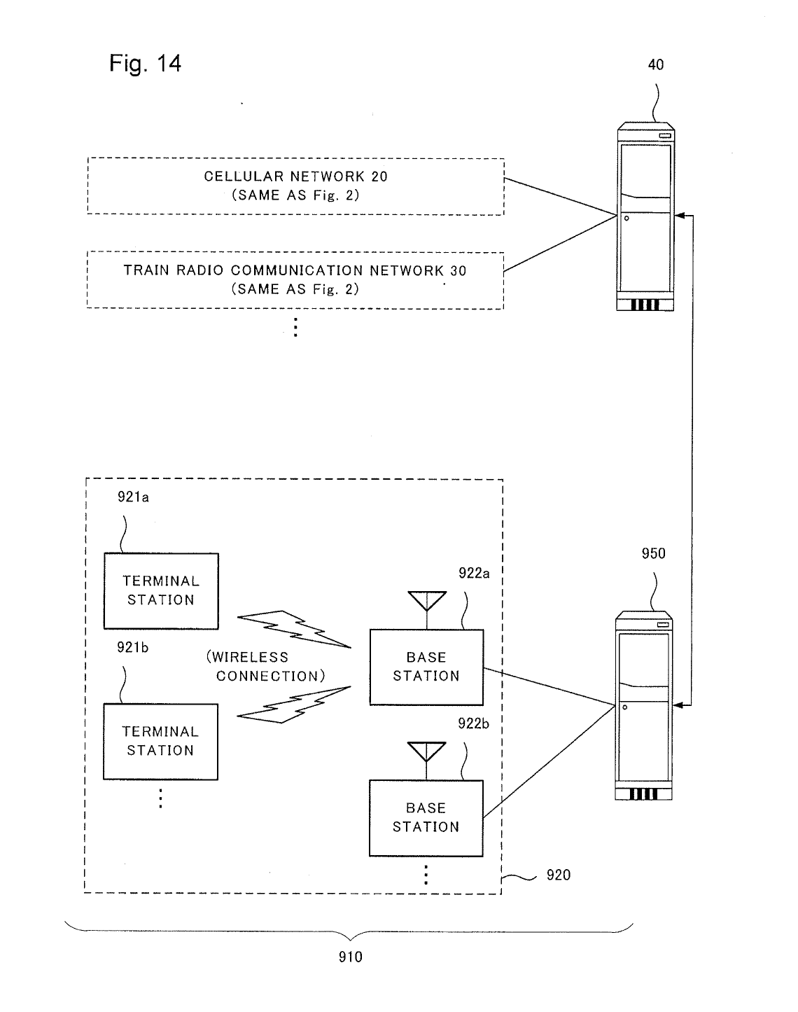

FIG. 14 is a diagram illustrating a configuration of the cognitive communication system 910 according to the fourth exemplary embodiment of the present invention. In the cognitive communication system 910, the above-described radio wave management device 850 of the radio wave management system 810 according to the third exemplary embodiment is replaced with a different radio wave management device 950 and the cognitive communication network 920 is further connected to the radio wave management device 950.

The cognitive communication network 920 is a radio communication network that carries out cognitive communications described in the section of Background Art and includes a number of terminal stations 921a, 921b, . . . and multiple base stations 922a, 922b, . . . .

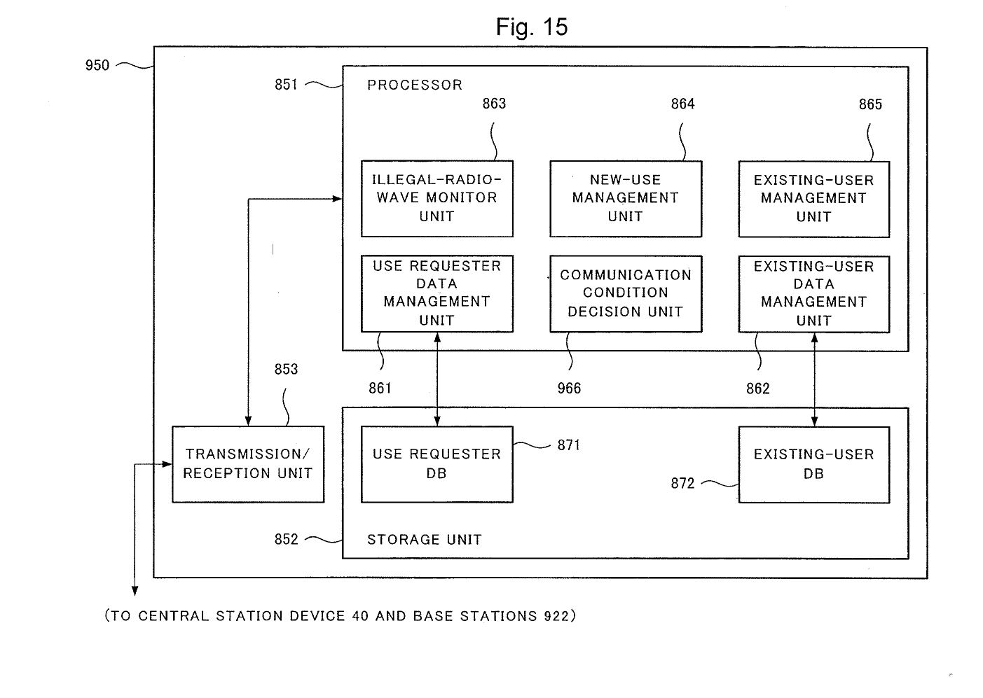

FIG. 15 is a diagram illustrating a more concrete configuration of the radio wave management device 950 illustrated in FIG. 14. The radio wave management device 950 is completely the same as the radio wave management device 850 of the third exemplary embodiment in terms of hardware and is also the same as the radio wave management device 850 in terms of software apart from that a communication condition decision unit 966 is added in the processor 851 operating as individual function units according to control based on a computer program.

The communication condition decision unit 966 decides communication conditions such as an available frequency band, bandwidth to be occupied, and power on the basis of the contents of the radio wave state database 322 recorded in the central station device 40 and the contents of the existing-user database 872, and transmits the communication conditions to the respective base stations 922a, 922b, . . . of the cognitive communication network 920. The base stations 922a, 922b, . . . further transmit the communication conditions to the terminal stations 921a, 921b, . . . via communication channels that are permitted in advance to use, and the terminal stations 921a, 921b, . . . and the base stations 922a, 922b, . . . carry out communications according to the conditions.

As described above, in the dynamic spectrum access cognitive radio, in which permission for use is dynamically given in response to secondary use requests, it is essential to reliably protect primary users. The cognitive communication system 910 in this exemplary embodiment can carry out communications in which unused frequency resources are secondarily used highly efficiently by reducing the margin while reliably protecting the primary users, on the basis of actually measured data collected by the central station device 40.

Besides, each of the terminal stations 921a, 921b, . . . of the cognitive communication network 920 may have a configuration of including an observation device capable of collecting radio wave states as those in the first exemplary embodiment and the second exemplary embodiment. With this configuration, it is possible to collect more detailed radio wave states and effectively use frequency resources. Obviously, the communication condition decision unit 966 may be included in a device different from the radio wave management device 950.

The present invention is described above on the basis of the particular exemplary embodiments illustrated in the drawings. However, the present invention is not limited to the exemplary embodiments illustrated in the drawings and may employ any known configuration as long as being capable of providing the effects of the present invention.

The main points of the new technical contents of the above-described exemplary embodiments are as follows. Note that, although part of or the entire of the above-described exemplary embodiments may be summarized as the following new techniques, the present invention is not necessarily limited to these.

(Supplementary Note 1) A radio wave observation system including:

a plurality of radio networks each of which includes a plurality of base stations and a number of terminal stations corresponding to each of the plurality of base stations and carries out radio communication between each of the terminal stations and the base station; and

a central station device that is connected to the base stations,

wherein each of the terminal stations includes an observation device that carries out radio wave observation when an instruction is issued by the central station device and that responds to the central station device with a result of the observation, and

wherein the central station device includes

a storage means that includes a radio wave state database in which a radio wave state in each measurement spot is recorded,

a terminal search function for identifying, for each measurement spot, a terminal station that has a current position closest to the measurement spot and is included in any one of the plurality of radio networks, and

a radio wave state collection function for instructing the identified terminal station to carry out radio wave observation and recording, in the radio wave state database, a result of the observation returned in response to the instruction.

(Supplementary Note 2) The radio wave observation system according to Supplementary Note 1, wherein the terminal search function of the central station device identifies the terminal station that has the current position closest to the measurement spot, by searching a terminal database that is included in the storage means and in which the current position of each of the terminal stations is recorded.

(Supplementary Note 3) The radio wave observation system according to Supplementary Note 2,

wherein the observation device of each of the terminal stations includes a position acquisition unit that acquires a current position of the terminal station, and

wherein the central station device includes a position information collection function for regularly acquiring the current position from each of the terminal stations and recording the current position in the terminal database.

(Supplementary Note 4) The radio wave observation system according to Supplementary Note 1, wherein each of the terminal stations includes a transmission unit that transmits a radio wave according to a condition instructed by the central station device.

(Supplementary Note 5) The radio wave observation system according to Supplementary Note 1, including a radio wave management device that monitors an illegal radio wave and manages a radio wave user, by using the radio wave state database recorded in the central station device.

(Supplementary Note 6) The radio wave observation system according to Supplementary Note 5, wherein the radio wave management device is connected to a cognitive communication network for carrying out cognitive communication and includes a communication condition decision unit that decides a usable communication condition on the basis of the radio wave state database and transmits the communication condition to the cognitive communication network.

(Supplementary Note 7) A central station device that is connected, via a plurality of radio networks each including a plurality of base stations and a number of terminal stations corresponding to each of the plurality of base stations and carrying out radio communication between each of the terminal stations and the base station, to the base stations, the central station device including:

a storage means that includes a radio wave state database in which a radio wave state in each measurement spot is recorded;

a terminal search function for identifying, for each measurement spot, a terminal station that has a current position closest to the measurement spot and is included in any one of the plurality of radio networks; and

a radio wave state collection function for instructing the identified terminal station to carry out radio wave observation and recording, in the radio wave state database, a result of the observation returned in response to the instruction.

(Supplementary Note 8) The central station device according to Supplementary Note 7, wherein the terminal search function identifies the terminal station that has the current position closest to the measurement spot, by searching a terminal database that is included in the storage means and in which the current position of each of the terminal stations is recorded.

(Supplementary Note 9) The central station device according to Supplementary Note 8, including a position information collection function that regularly acquires the current position from each of the terminal stations and records the current position in the terminal database.

(Supplementary Note 10) A radio wave observation method including, in a radio wave observation system that includes a plurality of radio networks each including a plurality of base stations and a number of terminal stations corresponding to each of the plurality of base stations and carrying out radio communication between each of the terminal stations and the base station, and a central station device connected to the base stations and including a radio wave state database in which a radio wave state in each measurement spot is recorded:

a terminal search function of the central station device identifies a terminal station, that has a current position closest to each measurement spot and is included in any one of the plurality of radio networks;

a radio wave state collection function of the central station device instructs radio wave observation to the identified terminal station;

upon receipt of the instruction, an observation device of the terminal station carries out radio wave observation accordingly and responding to the central station device with a result of the observation; and

the radio wave state collection function of the central station device records the returned result of the observation, in the radio wave state database.

(Supplementary Note 11) The radio wave observation method according to Supplementary Note 10,

wherein a position information collection function of the central station device regularly acquires a current position of each of the terminal stations acquired by a position acquisition unit included in advance in the terminal station and records the current position in an included terminal database, and

wherein the terminal search function of the central station device identifies the terminal station that has the current position closest to the measurement spot by searching the terminal database.

(Supplementary Note 12) A radio wave observation program causing, in a radio wave observation system that includes a plurality of radio networks, and a central station device, the each of radio network including a plurality of base stations and a number of terminal stations corresponding to each of the plurality of base stations and carrying out radio communication between each of the terminal stations and the base station, the central station device being connected to the base stations and including a radio wave state database in which a radio wave state in each measurement spot is recorded,

a processor, included in the central station device, executing:

a process of identifying, for each measurement spot, a terminal station that has a current position closest to the measurement spot and is included in any one of the plurality of radio networks;

a process of instructing the identified terminal station to carry out radio wave observation; and

a process of recording, in the radio wave state database, a result of the observation returned in response to the instruction.

(Supplementary Note 13) The radio wave observation program according to Supplementary Note 12, causing the processor included in the central station device to further execute:

a process of regularly acquiring the current position of each of the terminal stations acquired by a position acquisition unit included in advance in the terminal station and recording the current position in an included terminal database; and

a process of identifying the terminal station that has the current position closest to the measurement spot by searching the terminal database.

This application is based upon and claims the benefit of priority from Japanese patent application No. 2013-024560, filed on Feb. 12, 2013, the disclosure of which is incorporated herein in its entirety by reference.

### INDUSTRIAL APPLICABILITY

The present invention can be widely used in radio data communications. The larger the number of radio networks participating in the radio wave observation system is, the more effects of efficiently using frequency resources can be exerted.

### REFERENCE SIGNS LIST

1, 10, 610, 810 radio wave observation system terminal station
2a, 104, 704 observation device
3 base station
4, 40 central station device
5 storage means
5a, 322 radio wave state database
6, 314b terminal search function
7, 314c radio wave state collection function
20 cellular network
21, 621 mobile router
22 base station
30 train radio communication network
31 train terminal station
32 station-building base station
41, 104a, 204a, 851 processor
42, 104b, 204b, 852 storage unit
43, 102, 853 transmission/reception unit
101, 201 antenna
103, 311 signal processing unit
104c broadband antenna
104d position acquisition unit
104e, 704e observation unit
111, 213, 314, 711 control unit
112, 211, 312, 712 data analysis unit
113, 212, 313 data management unit
202 wireless transmission/reception unit
203 wireless signal processing unit
204 processing device
204c wired transmission/reception unit
214 wired signal processing unit
313a terminal database management function
313b radio wave state database management function
314a position information collection function
314b terminal search function
314c radio wave state collection function
321 terminal database
704f SDR transmission unit
850, 950 radio wave management device
861 use requester data management unit
862 existing-user data management unit
863 illegal-radio-wave monitor unit
864 new-use management unit
865 existing-user management unit
871 use requester database
872 exiting-user database
910 cognitive communication system
920 cognitive communication network
966 communication condition decision unit

1. A radio wave observation system comprising:
a plurality of radio networks each of which includes a plurality of base stations and a number of terminal stations corresponding to each of the plurality of base stations and carries out radio communication between each of the terminal stations and the base station; and
a central station device that is connected to the base stations,
wherein each of the terminal stations includes an observation device that carries out radio wave observation when an instruction is issued by the central station device, and that responds to the central station device with a result of the observation, and
wherein the central station device includes
a storage unit that includes a radio wave state database in which a radio wave state in each measurement spot is recorded,
a terminal search function for identifying, for each measurement spot, a terminal station that has a current position closest to the measurement spot and is included in any one of the plurality of radio networks, and
a radio wave state collection function for instructing the identified terminal station to carry out radio wave observation and recording, in the radio wave state database, a result of the observation returned in response to the instruction.

2. The radio wave observation system according to claim 1, wherein the terminal search function of the central station device identifies the terminal station that has the current position closest to the measurement spot, by searching a terminal database that is included in the storage unit and in which the current position of each of the terminal stations is recorded.

3. The radio wave observation system according to claim 2,
wherein the observation device of each of the terminal stations includes a position acquisition unit that acquires a current position of the terminal station, and
wherein the central station device includes a position information collection function for regularly acquiring the current position acquired by each of the terminal stations and recording the current position in the terminal database.

4. The radio wave observation system according to claim 1, wherein each of the terminal stations includes a transmission unit that transmits a radio wave according to a condition instructed by the central station device.

5. The radio wave observation system according to claim 1, comprising a radio wave management device that monitors an illegal radio wave and manages a radio wave user, by using the radio wave state database recorded in the central station device.

6. The radio wave observation system according to claim 5, wherein the radio wave management device is connected to a cognitive communication network for carrying out cognitive communication and includes a communication condition decision unit that decides a usable communication condition on the basis of the radio wave state database and transmits the communication condition to the cognitive communication network.

7. A central station device that is connected, via a plurality of radio networks each including a plurality of base stations and a number of terminal stations corresponding to each of the plurality of base stations and carrying out radio communication between each of the terminal stations and the base station, to the base stations, the central station device comprising:
a storage unit that includes a radio wave state database in which a radio wave state in each measurement spot is recorded;
a terminal search function for identifying, for each measurement spot, a terminal station that has a current position closest to the measurement spot and is included in any one of the plurality of radio networks; and
a radio wave state collection function for instructing the identified terminal station to carry out radio wave observation and recording, in the radio wave state database, a result of the observation returned in response to the instruction.

8. A radio wave observation method comprising, in a radio wave observation system that includes a plurality of radio networks each including a plurality of base stations and a number of terminal stations corresponding to each of the plurality of base stations and carrying out radio communication between each of the terminal stations and the base station, and a central station device connected to the base stations and including a radio wave state database in which a radio wave state in each measurement spot is recorded:
a terminal search function of the central station device identifies a terminal station, that has a current position closest to each measurement spot and is included in any one of the plurality of radio networks;
a radio wave state collection function of the central station device instructs radio wave observation to the identified terminal station;
upon receipt of the instruction, an observation device of the terminal station carries out radio wave observation accordingly and responding to the central station device with a result of the observation; and
the radio wave state collection function of the central station device records the returned result of the observation, in the radio wave state database.

9. The radio wave observation method according to claim 8,
wherein a position information collection function of the central station device regularly acquires a current position of each of the terminal stations acquired by a position acquisition unit included in advance in the terminal station and stores the current position in a terminal database, and
wherein the terminal search function of the central station device identifies the terminal station that has the current position closest to the measurement spot by searching the terminal database.

10. (canceled)
